(19) United States
(12) Patent Application Publication
(10) Pub. No.: US 2026/0034776 A1
(43) Pub. Date: Feb. 5, 2026

(54) METHOD FOR MANUFACTURING A PROFILED ELEMENT MADE OF COMPOSITE MATERIAL INCLUDING A PIGMENTED COATING, PROFILED ELEMENT OBTAINED FROM SAID METHOD

(71) Applicant: Airbus SAS, BLAGNAC (FR)

(72) Inventor: Jago PRIDIE, ROCHEFORT (FR)

(21) Appl. No.: 19/287,939

(22) Filed: Aug. 1, 2025

(30) Foreign Application Priority Data
Aug. 5, 2024 (FR) 2408638

(51) Int. Cl. B32B 27/12; B32B 1/00; B32B 5/02; B32B 37/20

(52) U.S. Cl. CPC B32B 27/12; B32B 1/00; B32B 5/026; B32B 37/203; B32B 2305/72; B32B 2307/4026

(57) ABSTRACT

A method for manufacturing a profiled element made of composite material including a step of obtaining a preform and a step of placing at least one pigmented layer on the preform, the pigmented layer including at least one pigmented film and at least one support structure having a knitted structure. Because the knitted structure is flexible, it is possible to obtain profiled elements with complex geometries. A profiled element obtained from such a method and a stiffened panel comprising at least one such profiled element are also provided.

### CROSS-REFERENCES TO RELATED APPLICATIONS

This application claims the benefit of the French Patent Application No. FR2408638 filed on Aug. 5, 2024, the entire disclosures of which are incorporated herein by way of reference.

### FIELD OF THE INVENTION

The present application relates to a method for manufacturing a profiled element made of composite material including a pigmented coating, to a profiled element made of composite material obtained from this method and to a stiffened panel produced using such a profiled element.

### BACKGROUND OF THE INVENTION

According to an embodiment visible in FIG. 1, a stiffened panel 10 comprises a wall 12 having first and second faces 12.1, 12.2 and a plurality of stiffeners 14 that are substantially parallel to one another, perpendicular to the wall 12 and positioned on the first face 12.1.

According to one mode of implementation visible in FIG. 2, a method for manufacturing a stiffened panel made of composite material comprises a step of manufacturing U-shaped or L-shaped profiled elements 16 made of composite material, a step of laying mandrels 18, each supporting a profiled element 16, on a laying surface 20 as shown in FIG. 2A, the bases 16.1 of the profiled elements 16 being substantially parallel to the laying surface 20 and spaced apart from the latter, a step of laying a skin 22 made of composite material on the bases 16.1 of the profiled elements 16 as shown in FIG. 2B, a step of putting in place a polymerization or consolidation tool 24 as shown in FIG. 2C and a step of polymerization or consolidation.

During the step of laying the mandrels 18, the latter are laid on the laying surface 20 and placed right next to one another so as to press a first wing 16.2 of a profiled element 16 of a first mandrel 18 against a second wing 16.3 of a profiled element 16 of a second mandrel 18, the first and second wings 16.2, 16.3 forming, after the step of polymerization or consolidation, a stiffener 14 of the stiffened panel 10.

According to one embodiment, a method for obtaining a U-shaped profiled element comprises a step of stacking plies of structural fibers flat so as to form a flat preform 26, a step of deformation of the flat preform 26 on a mold 28 in such a way as to bend the two wings 16.2, 16.3 of the profiled element 16 into a U shape, as shown in FIG. 4, then a step of at least partially hardening the bent preform. This method may comprise other steps such as a compacting step after the deformation step, a cutting step and a step of protecting the free edges of the wings 16.2, 16.3 prior to the hardening step.

According to one mode of implementation, the profiled elements 16 are subjected to a non-destructive inspection method in order to check that they are compliant.

To ensure that the measurements taken during the non-destructive inspection are reliable and to prevent the wave beam used for the non-destructive inspection from being reflected, at least one surface of the profiled element is covered with a pigmented coating after the hardening step, promoting the absorption of the wave beam.

The step of drying of this coating is relatively long, which significantly increases the time taken for manufacturing of the profiled elements 16.

To overcome this drawback, document FR3059591 proposes a method for obtaining a profiled element which comprises a step of stacking of plies of structural fibers flat so as to form a flat preform 26, a step of placing a pigmented layer on the flat preform 26, a step of deformation of the flat preform 26 coated with the pigmented layer on a mold 28 in such a way as to bend the two wings of the profiled element, then a step of hardening of the bent preform coated with the pigmented layer. This method may comprise other steps such as a compacting step after the deformation step, a cutting step and a step of protecting the free edges of the profiled element prior to the hardening step.

According to this mode of implementation, after the step of hardening of the profiled element coated with the pigmented layer, the latter has the same advantages as the paint coating after the step of hardening of the profiled element. Since the pigmented layer is hardened simultaneously with the plies of structural fibers of the profiled element and not in an additional step, this mode of implementation makes it possible to reduce the time required for manufacturing.

According to one embodiment, the pigmented layer comprises an extremely thin film of paint having a thickness of less than or equal to 50 μm. To make it possible to easily handle this film of paint without damaging it, the pigmented layer comprises a structure of woven fibers 30 supporting the film of paint.

According to a configuration of the prior art visible in FIG. 3, the structure of woven fibers 30 comprises warp and weft threads 30.1, 30.2 in a plain weave. According to this type of weave, each weft thread 30.2 passes alternately over then under each warp thread 30.1, producing a square pattern. Each of the warp and weft threads 30.1, 30.2 is oriented approximately straight.

Although this mode of obtaining a profiled element using a pigmented layer which combines a film of paint with a structure of woven fibers 30 makes it possible to significantly reduce the time required for manufacturing, it is not entirely satisfactory because it is reserved for profiled elements having a laying surface for the pigmented layer which is developable, and it is difficult to apply if the laying surface is not developable.

### SUMMARY OF THE INVENTION

The present invention aims to overcome all or some of the drawbacks of the prior art.

To this end, the invention relates to a method for manufacturing a profiled element made of composite material comprising a step of obtaining a preform and a step of placing at least one pigmented layer on the preform, the pigmented layer including at least one pigmented film and at least one support structure having a face against which the pigmented film is applied.

According to the invention, the support structure of the pigmented layer has a knitted structure.

Because a knitted structure is more flexible than a woven structure, it is possible, using the method of the invention, to obtain profiled elements with complex geometries.

According to another feature, the knitted structure is a warp knitted structure.

According to another feature, the knitted structure is a weft knitted structure.

According to another feature, the preform is shaped before the step of placing the pigmented layer, the method comprising a step of shaping the pigmented layer before the step of placing the pigmented layer on the shaped preform.

According to another feature, the pigmented film is applied flat against the flat support structure, then the pigmented film and the support structure, pressed against one another, are cured then deformed simultaneously.

According to another feature, the support structure and the pigmented film are subjected, during deformation, to a forming temperature higher than the glass transition temperature of the pigmented film.

The invention also relates to a profiled element made of composite material obtained from a manufacturing method according to one of the above features, and to a stiffened panel obtained from such a profiled element.

### BRIEF DESCRIPTION OF THE DRAWINGS

Further features and advantages will emerge from the description of the invention below, which is provided solely by way of example, with reference to the attached drawings in which:

FIG. 1 is a perspective view of a stiffened panel,

FIGS. 2A-2C schematically depict various steps in the manufacture of a panel, showing an embodiment of the prior art,

FIG. 3 is an end-on view of part of a structure of woven fibers, showing an embodiment of the prior art,

FIG. 4 schematically depicts a tool for forming a flat preform so as to obtain a U-shaped profiled element,

FIG. 5 is an end-on view of part of a knitted structure, showing an embodiment of the invention,

FIG. 6 is an end-on view of part of a knitted structure, showing another embodiment of the invention,

FIGS. 7A-7C schematically depict various steps of forming of a pigmented layer,

FIG. 8 schematically depicts a tool for obtaining a profiled element, showing an embodiment of the invention,

FIGS. 9A-9C are perspective views of various profiled elements obtained using the method of the invention.

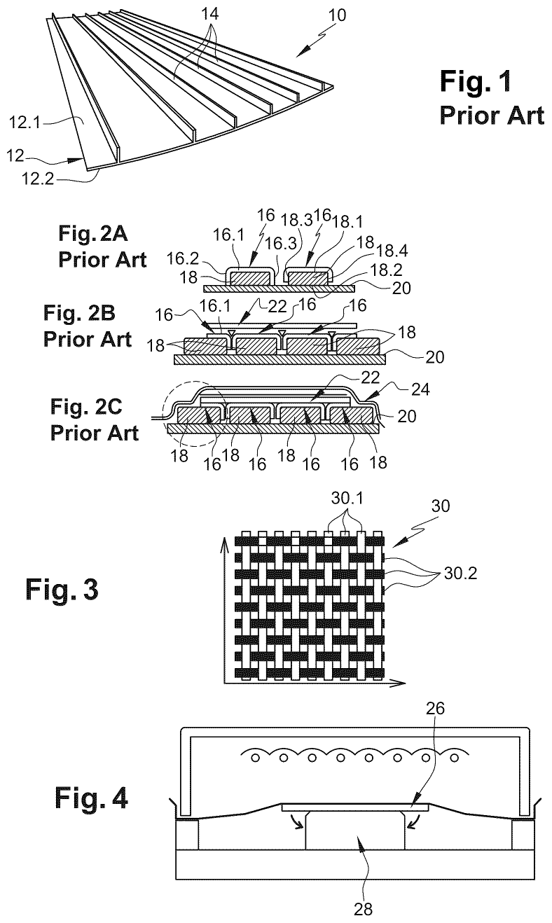

### DETAILED DESCRIPTION OF THE PREFERRED EMBODIMENTS

According to one mode of implementation, a method for manufacturing a stiffened panel made of composite material comprises a step of manufacturing U-shaped or L-shaped profiled elements made of composite material, a step of laying mandrels, each supporting a profiled element, on a laying surface, the bases of the profiled elements being substantially parallel to the laying surface and spaced apart from the latter, a step of laying a skin made of composite material on the bases of the profiled elements, a step of putting in place a polymerization or consolidation tool and a step of polymerization or consolidation.

According to one application, an aircraft comprises at least one stiffened panel obtained using this method. By way of example, a center wing box of an aircraft comprises at least one stiffened panel obtained using this method.

The method for manufacturing a stiffened panel will not be described in more detail since, with the exception of the step of manufacturing the profiled element, it may be identical to the prior art method.

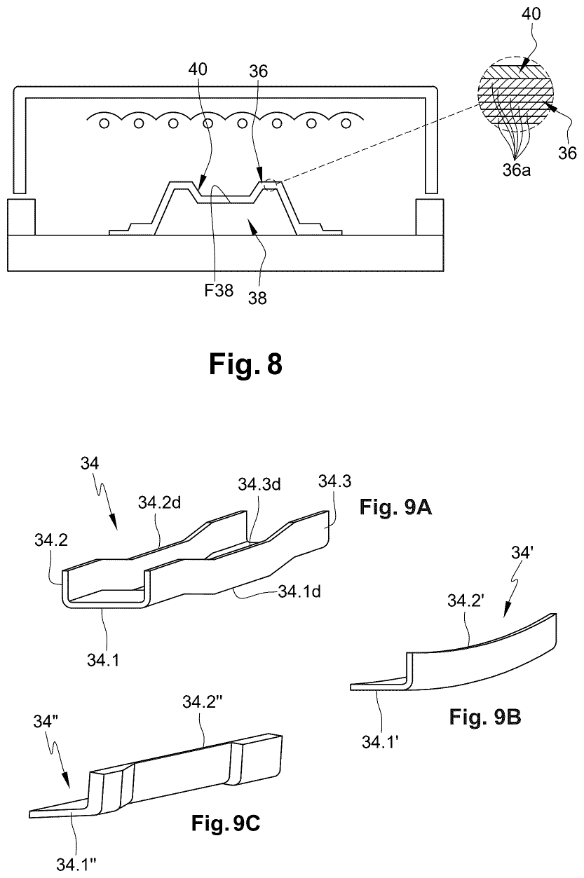

According to an embodiment visible in FIG. 8, a method for obtaining a profiled element 34 (visible in FIG. 9) comprises a step of stacking plies of structural fibers 36a on a mold 38 in such a way as to obtain a shaped preform 36. The mold 38 has a stacking surface F38 having a geometry approximately identical to the geometry of the profiled element 34 resulting from the method for obtaining same. In the case of a profiled element 34 with a non-developable geometry, the stacking surface F38 also has a non-developable geometry.

This method may comprise other steps such as a compacting step during or after the stacking step, a cutting step and a step of protecting the free edges of the shaped preform prior to a hardening step.

The stacking and hardening steps will not be described in more detail since they may be identical to those in the prior art.

Depending on the case, the shaped preform may have a U-shaped, L-shaped or other cross section.

When the profiled element is used to produce a stiffened panel, according to a first variant, the step of hardening of the shaped preform may be carried out before the step of laying the mandrel supporting the shaped preform on the laying surface. According to a first case, the shaped preform may be partially polymerized or consolidated before the laying step, the end of polymerization or consolidation being carried out simultaneously with that of the skin. According to a second case, the shaped preform is fully polymerized or consolidated before the laying step.

According to another variant, the hardening step is carried out after the step of laying the mandrel supporting the shaped preform on the laying surface. In this case, the shaped preform is completely uncured when it is laid on the laying surface.

The method for obtaining the profiled element comprises a step of placing at least one pigmented layer 40 on the preform before the hardening step.

According to an embodiment visible in FIG. 7A, the pigmented layer 40 comprises at least one pigmented film 42 and at least one support structure 44 having a face against which the pigmented layer 40 is applied.

According to one configuration, the pigmented film 42 is an extremely thin film of paint having a thickness of less than or equal to 50 μm. This pigmented film 42 will not be described in more detail since it may be identical to the films of paint in the prior art.

According to one embodiment, the pigmented film 42 is initially flat. According to one mode of implementation, the flat pigmented film 42 is placed on the support structure 44, which is also flat. Next, the pigmented film 42 and the support structure 44, pressed against one another, are cured then deformed simultaneously. The pigmented film 42 is deformed on the support structure 44 already formed. According to one configuration, the pigmented film 42 has a glass transition temperature Tg lower than the forming temperature. Thus, during deformation, the pigmented film 42 softens and may deform by adapting to a non-developable three-dimensional shape.

According to another mode of implementation, the pigmented film 42 is partially cured before being applied against the support structure 44. The pigmented film 42 and the support structure 44 are then joined by adhesive bonding.

According to another embodiment, the pigmented layer 40 only comprises a support structure 44 impregnated with pigments.

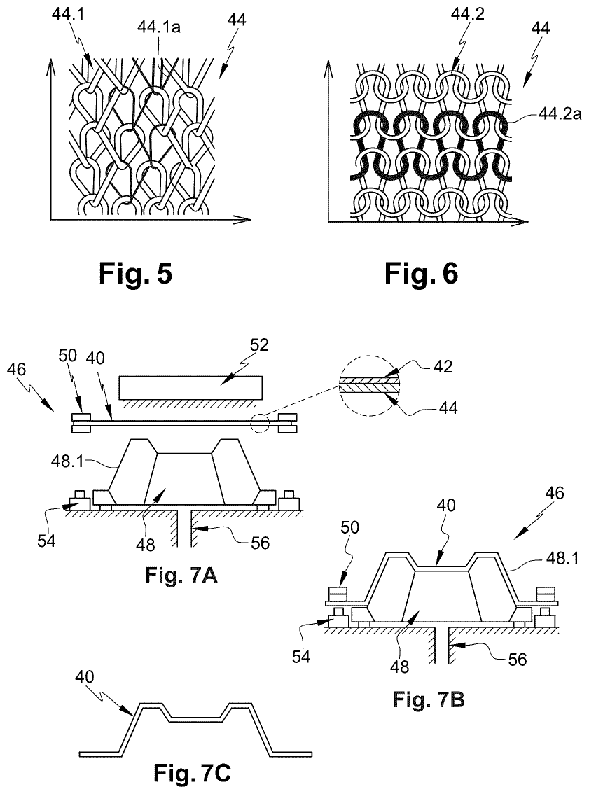

According to a particular feature of the invention, the support structure 44 is a knitted structure 44.1, 44.2, as shown in FIGS. 5 and 6. Thus, the knitted structure 44.1, 44.2 comprises loops of interconnected threads. This type of structure is more flexible than a woven structure and, unlike a woven structure, may adapt to follow a non-developable surface, without plies.

According to a first embodiment visible in FIG. 5, the knitted structure 44.1 is a warp knitted structure. It comprises only warp threads 44.1a positioned in the lengthwise direction of the knitted structure 44.1, each of them forming loops interlinked with the loops of another warp thread 44.1a in such a way as to form columns of stitches oriented in the lengthwise direction of the knitted structure.

According to a second embodiment visible in FIG. 6, the knitted structure 44.2 is a weft knitted structure. It comprises only weft threads 44.2a positioned in the widthwise direction of the knitted structure, each of them forming loops interlinked with the loops of another weft thread 44.2a in such a way as to form rows of stitches oriented in the widthwise direction of the knitted structure.

Like the structure of woven fibers of the prior art, the knitted structure 44.1, 44.2 protects the pigmented film 42. Unlike the structure of woven fibers 30 of the prior art which can only adapt without plies on a developable surface, the knitted structure 44.1, 44.2 can adapt without plies on a non-developable surface. Thus, by virtue of the knitted structure 44.1, 44.2, it is possible to obtain U-shaped or L-shaped profiled elements 34, 34, 34″ with complex geometries.

According to an embodiment visible in part FIG. 9A, a U-shaped profiled element 34 comprises a base 34.1 and two wings 34.2, 34.3, the base 34.1 and the upper edges of the wings 34.2, 34.3 each having a recess 34.1d, 34.2d, 34.3d.

According to another embodiment visible in FIG. 9B, an L-shaped profiled element 34′ comprises first and second curved wings 34.1′, 34.2′.

According to another embodiment visible in FIG. 9C, an L-shaped profiled element 34″ comprises first and second wings 34.1″, 34.2″, the second wing 34.2″ having a thickness that is not constant.

Naturally, the invention is not limited to these embodiments for the profiled element.

According to one mode of implementation, the method for obtaining a profiled element 34 comprises a step of obtaining a preform 36 having a stack of structural plies 36a and a surface to be covered with a pigmented layer 40, a step of obtaining a pigmented layer 40 shaped approximately like the surface of the preform 36 to be covered, a step of placing the pigmented layer 40 on the preform 36 and a step of co-curing the preform 36 and the pigmented layer 40 in such a way as to obtain a profiled element 34 at least partially covered with a pigmented layer 40.

According to an embodiment more particularly suited to a profiled element 34 having a non-developable geometry, during the step of obtaining the preform 36, the latter is shaped like the profiled element 34 to be obtained, the structural plies 36a being laid on a stacking surface F38 having a geometry approximately identical to that of the profiled element 34 to be obtained.

In parallel, during the step of obtaining a shaped pigmented layer 40, the pigmented film 42 is applied flat against the support structure 44, which is also flat. Next, the pigmented film 42 and the support structure 44 are cured then deformed simultaneously. During this deformation, the support structure 44 and the pigmented film 42 are subjected to a forming temperature that is higher than the glass transition temperature Tg of the pigmented film 42, which allows the latter to be shaped with a non-developable geometry and ensures significant cohesion between the support structure 44 and the pigmented film 42. Since the support structure 44 is a knitted structure, it may be shaped with a non-developable geometry.

Whatever the embodiment, the profiled element made of composite material obtained comprises at the surface a pigmented layer 40 including a pigmented film 42 added to a support structure 44 having a knitted structure 44.1, 44.2.

According to an embodiment visible in FIGS. 7A-7C, a shaping tool 46 for shaping the pigmented layer 40 comprises at least one mold 48 including a laying surface 48.1 having a geometry identical to that of the surface of the shaped preform 36 against which the pigmented layer 40 is to be laid, at least one holder 50 configured to hold the flat pigmented layer 40 and press it against the mold 48. According to one configuration, the shaping tool 46 comprises a heating system 52 configured to heat the pigmented layer 40 so as to soften it in such a way that it follows the laying surface 48.1 and/or cure it. According to one arrangement, the holder 50 is a frame and the heating system 52 is positioned above the mold 48. The latter comprises a sealing system 54 around the laying surface 48.1 and a suction system 56 configured to draw off the gas present between the mold 48 and the pigmented layer 40 and press the latter against the laying surface 48.1. According to one mode of implementation, the pigmented layer 40 is connected to the holder 50 positioned between the mold 48 and the heating system 52 as shown in FIG. 7A. Next, the heating system 52 is activated to soften the pigmented layer 40. When the latter is sufficiently soft, the holder 50 is moved toward the mold 48 until the pigmented layer 40 is in contact with the sealing system 54. During this movement, the softened pigmented layer 40 deforms against the laying surface 48.1. As shown in FIG. 7B, the suction system 56 is activated in such a way that the pigmented layer 40 follows the laying surface 48.1. After a predetermined time, the heating system 52 and suction system 56 are deactivated. After a period of cooling, the deformed pigmented layer 40 is separated from the mold 48 and detached from the holder 50, as shown in FIG. 7C. According to one mode of implementation, the pigmented film 42 is cured while it is flat before being deformed.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing a profiled element made of composite material comprising:
a step of obtaining a preform, and
a step of placing at least one pigmented layer on the preform, the pigmented layer including at least one pigmented film and at least one support structure having a face against which the pigmented film is applied;
wherein the at least one support structure of the pigmented layer has a knitted structure.

2. The manufacturing method as claimed in claim 1, wherein the knitted structure is a warp knitted structure.

3. The manufacturing method as claimed in claim 1, wherein the knitted structure is a weft knitted structure.

4. The manufacturing method as claimed in claim 1,
wherein the preform is shaped before the step of placing the pigmented layer, and
wherein the method comprises a step of shaping the pigmented layer before the step of placing the pigmented layer on the shaped preform.

5. The manufacturing method as claimed in claim 4, wherein the pigmented film is applied flat against the support structure while the support structure is in a flat configuration, the pigmented film and the support structure, pressed against one another, then being cured then deformed simultaneously.

6. The manufacturing method as claimed in claim 5,
wherein the pigmented film has a glass transition temperature, and
wherein the support structure and the pigmented film are subjected, during deformation, to a forming temperature higher than the glass transition temperature of the pigmented film.

7. A profiled element made of composite material obtained from a manufacturing method as claimed in claim 1, said profiled element comprising a support structure having a knitted structure, to which a pigmented film is added.

8. A stiffened panel comprising profiled elements as claimed in claim 7.
